(19) United States
(12) Patent Application Publication
(10) Pub. No.: US 2026/0341042 A1
(43) Pub. Date: Oct. 29, 2026

(54) METHOD FOR PROCESSING A PLURALITY OF IMAGES ACQUIRED BY A CAMERA ON BOARD A SPECIFIC VEHICLE

(71) Applicant: AUMOVIO Autonomous Mobility Germany GmbH, Ingolstadt (DE)

(72) Inventors: Thibault CARON, Toulouse (FR); Bilal HIJAZI, Toulouse (FR); Litong ZHANG, Toulouse (FR)

(73) Assignee: AUMOVIO Autonomous Mobility Germany GmbH, Ingolstadt (DE)

(21) Appl. No.: 19/491,193

(22) PCT Filed: Jul. 18, 2024
(86) PCT No.: PCT/EP2024/070424

§ 371 Date: Dec. 8, 2025

(30) Foreign Application Priority Data
Jul. 19, 2023 (FR) FR2307742

(51) Int. Cl. G06V 20/58; G06V 10/25; G06V 10/56; G06V 10/60; G06V 10/764

(52) U.S. Cl. CPC G06V 20/584; G06V 10/25; G06V 10/56; G06V 10/60; G06V 10/764; G06V 2201/08

(57) ABSTRACT

A method for processing a plurality of images acquired by a camera on board a specific vehicle. Each image of the plurality of images being associated with a respective acquisition time. The method making it possible in particular to determine a priority vehicle detection index indicating the probability that a detected vehicle in images of the plurality of images is a priority vehicle.

### CROSS-REFERENCE TO RELATED APPLICATIONS

This application is the U.S. National Phase Application of PCT International Application No. PCT/EP2024/070424, filed Jul. 18, 2024, which claims priority to French Patent Application No. FR 2307742, filed Jul. 19, 2023, the contents of such applications being incorporated by reference herein.

### DESCRIPTION

### FIELD OF THE INVENTION

The present disclosure relates to the field of vehicle driving assistance functions.

### BACKGROUND OF THE INVENTION

In the context of vehicle driving assistance functions, and in particular in the context of vehicle autonomous driving functions, it is advantageous to be able to detect priority vehicles which are traveling, in particular so as to make it easier for them to pass.

A priority vehicle may, for example, correspond to a police vehicle, a medical vehicle such as an ambulance or a medical taxi, a fire truck, a construction vehicle, etc. These vehicles are in particular provided with flashing emergency lights and possibly sirens when they are in operation in order to warn other drivers of their presence.

Document US2019101928, incorporated herein by reference, describes a computer device of a first vehicle capable of receiving a first image and a second image of a second vehicle having flashing light signals. The computer device may determine, in the first image and the second image, an image region which delimits the second vehicle such that the image region substantially encompasses the second vehicle. The computer device determines a polar grid which divides the image region in the first image and the second image into polar compartments, and identifies portions of image data that exhibit a change in color and a change in brightness between the first image and the second image. The computer device may determine a type of flashing light signals and a type of the second vehicle; and accordingly provides instructions for controlling the first vehicle.

The solution described in this document requires the partitioning of the encompassing box representing the target vehicle using a polar system, this being limiting. In addition, consideration of the whole of the encompassing box also has the drawback of risking returning a large number of false positives, in particular related to complex cases such as:
reflections due to the sun, which may cause changes in brightness or in color from one cycle to another;
some emergency lights are amber in some countries and have similar flashing frequencies to lane-changing lights.

Document WO2022079113A1, incorporated herein by reference, describes a method for processing a video stream of images captured by a color camera to detect a priority vehicle by carrying out a step of acquiring a sequence of images, then, for each image of the sequence of images, a step of color segmentation by thresholding making it possible to detect colored light zones, a step of tracking each segmented light zone, a step of classifying the colors of each segmented light zone, a step of frequency analysis of each segmented light zone making it possible to determine a flashing nature of the zone, a step of calculating an overall reliability index of each image of the sequence of images, making it possible to identify a light zone as a rotating beacon.

Although effective, this solution still has limitations for detecting non-stationary flashing lights such as those lights present on an emergency vehicle. Specifically, when a flashing light is off, it is not measured by the segmentation, and inefficient tracking does not make it possible to carry out the frequency analysis necessary to detect the rotating beacon.

The present disclosure presents a solution which makes it possible to assist in the detection of this type of vehicle during its operation, without the above-mentioned drawbacks.

### SUMMARY OF THE INVENTION

In this respect, a method for processing a plurality of images acquired by a camera on board a specific vehicle is proposed, each image of the plurality of images being associated with a respective acquisition time, the method comprising the following operations:
detecting at least one vehicle traveling in the same direction as the specific vehicle from the plurality of acquired images;
determining, for a detected vehicle, a plurality of zones of interest of the vehicle shared by images of the plurality of images and being likely to comprise at least one flashing emergency light of a priority vehicle;
detecting lights present in the images of the plurality of images;
creating a record indicating, for each image of the plurality of images, a presence or an absence of a light in each of the zones of interest from the detected lights;
determining, for at least one zone of interest, a zone confidence index from the information associated with the zone of interest in question listed in the record; and
determining a priority vehicle detection index indicating the probability that the detected vehicle is a priority vehicle from a zone confidence index of at least one zone of interest of the detected vehicle.

Optionally, the determination of a zone confidence index of a zone of interest comprises, when a light of one and the same color has been detected in a plurality of images of the plurality of images as being at least partially in the zone of interest, determining at least one characteristic among:
a flashing frequency of the detected light;
a flashing variance in the detected light;
an average phase duration during which the detected light is on; or
an average phase duration during which the detected light is off.

According to this option, the confidence index associated with a zone of interest of the detected vehicle is determined from the at least one characteristic.

Optionally, a zone confidence index is associated with a specific color, so that a specific zone of interest is associated with a plurality of confidence indices when a plurality of lights of different colors have been respectively detected in a plurality of images of the plurality of images as present in the zone of interest.

Optionally, the method further comprises the following operations:
determining, for a detected vehicle, at least one region of interest comprising a plurality of zones of interest;
determining, for each region of interest, a region confidence index, the region confidence index of a region of interest being determined from at least one zone confidence index of a zone of interest belonging to the region of interest.

According to this option, a priority vehicle detection index is determined from a region confidence index of at least one region of interest.

Optionally, the method further comprises the following operation:
classifying a zone of interest as being active or inactive depending on a value of a confidence index associated therewith.

In this option, a region confidence index of a region of interest is also determined from a weight calculated depending on at least one among:
a) a positioning of the zones of interest classified as being active in a region of interest; or
of interest.

Optionally, a specific detected vehicle is a car or a truck;
and the at least one specific region of interest determined for the specific detected vehicle comprises at least one region of interest among:
a) a first region of interest corresponding to an upper portion of the specific vehicle positioned at the level of the roof in the image; or
b) a second region of interest corresponding to a central band of the specific vehicle and extending between the two front lights of the specific vehicle.

Optionally, the second region of interest is devoid of the direction indicators of the vehicle.

Optionally, a specific detected vehicle is a motorcycle and the plurality of zones of interest of the motorcycle comprise at least one zone of interest among:
a) a first zone of interest corresponding to a first side band extending from a first end of the windshield of the motorcycle and comprising a first rear-view mirror of the motorcycle;
windshield of the motorcycle that are located in one and the same horizontal plane; or
c) a third zone of interest corresponding to a second side band extending from a second end of the windshield of the motorcycle and comprising a second rear-view mirror of the motorcycle.

Optionally, when the priority vehicle detection index is greater than a predetermined detection threshold for a detected vehicle, the method further comprises the following operation:
identifying the detected vehicle as corresponding to a priority vehicle.

The application also relates to a data-processing device configured to perform any one of the methods described in the present disclosure.

The application further relates to a computer program product comprising instructions for performing any one of the methods presented by the present disclosure when this program is executed by a processor.

Finally, the application relates to a computer-readable non-transitory storage medium on which is stored a program for performing any one of the methods presented by the present disclosure when this program is executed by a processor.

The method presented by the present disclosure thus makes it possible to determine an index indicating the probability that a vehicle detected by a camera on a vehicle is a priority vehicle. It also makes it possible, in certain examples, to determine whether or not the detected vehicle is a priority vehicle. The method is particularly advantageous for driving assistance functions since these functions can use this information to act accordingly, and in particular to make it easier for detected priority vehicles to pass if necessary. Moreover, insofar as the method relies on pre-existing vehicle detection and light detection functions, its implementation does not require significant modification of the consequent software architecture present in vehicles using driving assistance functions and/or autonomous driving functions.

### BRIEF DESCRIPTION OF THE DRAWINGS

Further features, details and advantages will become apparent from reading the following detailed description and from analyzing the appended drawings, in which:

FIG. 1 schematically shows an example of a data-processing device which is able to be configured to perform a method for processing a plurality of images acquired by a camera on board a vehicle.

FIG. 2 shows an example of a flowchart of a method for processing a plurality of images acquired by a camera on board a vehicle.

FIG. 3A schematically shows a view of the front face of an ambulance.

FIG. 3B schematically shows a view of the front face of a motorcycle.

FIG. 4 shows examples of patterns of zones of interest with which a weight may be associated.

### DESCRIPTION OF THE EMBODIMENTS

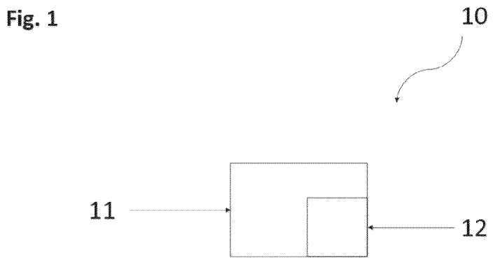

A data-processing device 10 configured to perform the processing operations described below on the images acquired by a camera is now described with reference to FIG. 1. The processing device 10 may, for example, comprise a computer 11 allowing all or some of the processing operations described below to be performed, and a memory 12 storing the code instructions executed by the computer.

The computer 11 may, for example, be of processor, microprocessor, microcontroller, FPGA, etc. type. The memory 12 may, for example, comprise a read-only memory (ROM), a random-access memory (RAM), an electrically erasable programmable read-only memory (EEPROM) or any other suitable types of storage means. The memory may, for example, comprise optical, electronic or else magnetic storage means. It may, for example, be designed to store the images acquired by the camera.

The camera capturing the images is on board a vehicle (not shown). It may be a rear camera of a vehicle, for example the reversing camera of the vehicle. The data-processing device 10 may also be on board the vehicle along with the camera or be disposed at a distance from the vehicle. In this second case, the vehicle comprises wireless communication means designed to communicate the images acquired by the camera on board the vehicle.

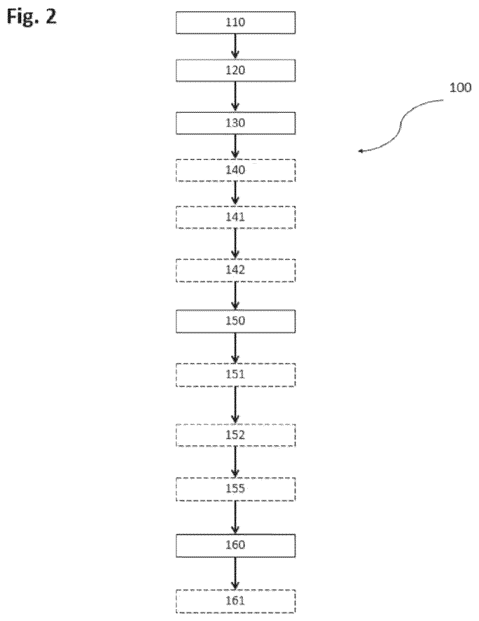

With reference to FIG. 2, an example of a method 100 for processing a plurality of images acquired by a camera on board a specific vehicle is presented.

The image-processing method according to the present disclosure makes it possible to determine a priority vehicle detection index indicating the probability that a vehicle detected in the images acquired by the camera is a priority vehicle.

As explained above, a priority vehicle may, for example, correspond to a police vehicle, a medical vehicle such as an ambulance or a medical taxi, a fire truck, a construction vehicle, etc. A priority vehicle according to the present disclosure is in particular provided with flashing emergency lights.

As illustrated by FIG. 2, the method 100 comprises an operation 110 of detecting at least one vehicle traveling in the same direction as the specific vehicle from the plurality of images acquired by the camera on board the specific vehicle.

Algorithms for detecting traveling vehicles are known to those skilled in the art. An example of one of these algorithms is in particular described by the document Sultana, Fahmida & Naimur, S & Amin, Md. (2022), incorporated herein by reference. Traffic Participants Detection and Classification Using YOLO Neural Network. 09-18. 10.5281/zenodo.6844336, incorporated herein by reference.

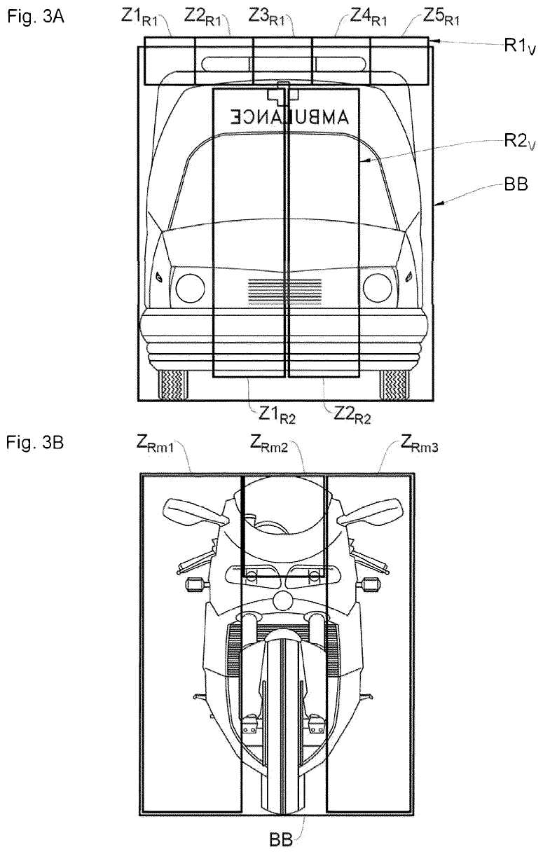

This type of algorithm generally allows the vehicles detected in the images to be delimited by limitation frames BB (generally known under the name “bounding box”), for example rectangular in shape, that are well known to those skilled in the art. In the case where the camera that acquired the images is a camera located at the rear of the vehicle, the detected vehicles traveling in the same direction as the specific vehicle are visible via their front face. With reference to FIGS. 3A and 3B, an example of a limitation frame BB surrounding the front face of an ambulance and the front face of a motorcycle, respectively, which could, for example, be detected by the method 100 during operation 110 has been shown.

As illustrated by FIG. 2, the method 100 comprises an operation 120 of determining a plurality of zones of interest Zᵣ on a vehicle detected following operation 110. The zones of interest Zᵣ are zones of the detected vehicle that are present in a plurality of images of the plurality of acquired images and advantageously that are present in each of these images. A zone of interest Zᵣ designates a zone likely to comprise at least one flashing emergency light of a priority vehicle and preferably exactly one flashing emergency light. The operation 120 of determining a plurality of zones of interest Zᵣ on a detected vehicle following operation 110 may advantageously be carried out for each detected vehicle.

The position of the plurality of zones of interest Zᵣ depends on the type (truck, car, motorcycle, etc.) of the vehicle detected in step 110. To this extent, operation 110 of detecting at least one vehicle may comprise classifying the at least one detected vehicle by type. This classification may in particular be carried out on the basis of a height of the vehicle, a width of the vehicle, a number of wheels of the vehicle, classification algorithms using neural networks or machine learning, etc.

In first examples in which the detected vehicle corresponds to a car or to a truck, the plurality of zones of interest Zᵣ may comprise at least one among:
a first plurality of zones of interest Z_{R1} positioned at the level of the roof of the detected vehicle, advantageously at the level of the front face of the vehicle; and/or
a second plurality of zones of interest Z_{R2} positioned in a central band of the detected vehicle extending between the two front lights of this vehicle.

These first examples are in particular shown in FIG. 3A schematically illustrating a front view of an ambulance truck in which the first plurality of zones of interest Z_{R1} is identified by the references ranging from Z1_{R1} to Z5_{R1} and the second plurality of zones of interest Z_{R2} is identified by the references Z1_{R2} and Z2_{R2}. Vans and medical taxis are considered to correspond to the “car” type of vehicle in the present application.

In second examples in which the detected vehicle corresponds to a motorcycle, a plurality of zones of interest Zᵣ may comprise at least one among:
a first zone of interest Z_{Rm1} corresponding to a first side band extending from a first end of the windshield of the motorcycle and comprising a first rear-view mirror of the motorcycle,
a second zone of interest Z_{Rm2} extending between two ends of the windshield of the motorcycle that are located in one and the same horizontal plane,
a third zone of interest Z_{Rm3} corresponding to a second side band extending from a second end of the windshield of the motorcycle and comprising a second rear-view mirror of the motorcycle.

These second examples are in particular shown in FIG. 3B schematically illustrating a front view of a motorcycle.

As illustrated in FIG. 2, the method 100 comprises an operation 130 of detecting lights present in the images of the plurality of images, and advantageously lights having a color corresponding to a flashing emergency light. Known algorithms make it possible to detect lights in the images. In particular, a light may, for example, be identified in an image on the basis of the colorimetry of the pixels of the image. For example, there may be predefined, in a colorimetric space, ranges of pixel values associated with red light, with blue light, with orange light, or with any light possibly corresponding to light having the color of a flashing emergency light. In this way, pixels exhibiting this colorimetry in an image may be identified as belonging to a light in the image. A light in an image associated with a specific color may, for example, correspond to all the neighboring pixels of an image which have a value comprised in the range of values associated with this specific color.

As illustrated in FIG. 2, the method 100 comprises an operation 140 of creating a record indicating, for each image of the plurality of images, a presence or an absence of a light in each of the zones of interest Zᵣ determined for the detected vehicle. Operation 140 may, for example, comprise identifying 141, in each image of the plurality of images, lights comprised at least partially in a zone of interest Zᵣ of the detected vehicle, then associating 142 this light with this zone of interest in the record. In particular, the color of the light associated with the zone of interest and with the image may be indicated in the record. This operation involves determining which lights at least partially comprised in a zone of interest Zᵣ of the detected vehicle are likely to comprise at least one flashing emergency light of the vehicle in order to determine whether a zone of interest may resemble a flashing emergency light, thus making it possible to determine whether the detected vehicle may be a priority vehicle. Thus, the record obtained indicates, for each zone of interest, the presence or the absence of light for each image, and possibly the color of the light present in the zone in the images.

In examples in which the pixels composing a light are comprised in a plurality of zones of interest Zᵣ of the vehicle in an image, the light may be associated with the zone of interest Zᵣ comprising a central pixel of the light or may be associated with the zone of interest Zᵣ comprising the largest number of pixels composing the light among the zones of interest Zᵣ comprising pixels of the light.

As illustrated in FIG. 2, the method then comprises an operation 150 for determining, for at least one zone of interest Zr, a zone confidence index from the information associated with the zone of interest in question listed in the record. A zone confidence index may advantageously be determined for each zone of interest Zr determined for the detected vehicle.

In examples, the determination 150 of a zone confidence index of a zone of interest Zᵣ comprises, when a light of one and the same color has been detected in a plurality of images of the plurality of images as being at least partially in the zone of interest Zr, determining 151 at least one characteristic among:
a flashing frequency of the detected light;
a flashing variance in the detected light;
an average phase duration during which the detected light is on; or
an average phase duration during which the detected light is off.

In these examples, a zone confidence index associated with a zone of interest Zᵣ of the detected vehicle is determined from the at least one characteristic obtained during operation 151.

These characteristics make it possible to determine the behavior of the lights associated with a zone of interest Zr, and in particular their possibly flashing nature. Specifically, by definition, a flashing emergency light is not always on, and so a light will not be detected in the images captured by the on-board camera for which the flashing light is off. Thus, by analyzing in particular the on and off frequency of a zone of interest Zr, it is possible to determine a confidence index expressing the probability that the zone of interest comprises a flashing emergency light.

In examples, when no light is detected as being comprised at least partially in a zone of interest Zᵣ in the plurality of images, the zone confidence index associated with the zone of interest Zᵣ may be determined to be equal to 0.

In examples, a zone of interest Zᵣ is associated with a plurality of confidence indices when a plurality of lights of different colors have been respectively detected in a plurality of images of the plurality of images as present in the zone of interest. In these examples, each confidence index of the plurality of confidence indices associated with a specific zone of interest Zᵣ is associated with a respective color among the plurality of different colors of the lights detected in the specific zone of interest Zr.

As illustrated in FIG. 2, the method comprises an operation 160 of determining a priority vehicle detection index indicating the probability that the detected vehicle is a priority vehicle from a zone confidence index of at least one zone of interest Zᵣ of the detected vehicle. Advantageously, the priority vehicle detection index may be determined from each of the zone confidence indices determined at the end of operation 150.

Moreover, operations 120 to 160 may be carried out for each vehicle detected at the end of operation 110.

The method according to the present disclosure thus ingeniously combines pre-existing software functions for detecting lights in an image and detecting vehicles by image analysis in order to determine an index indicating the probability that a detected vehicle is a priority vehicle.

The presented method thus ends up addressing a practical driving assistance situation, particularly advantageous in the context of autonomous driving, which requires the detection of priority vehicles in operation traveling close to a vehicle in question, for example in order to make it easier for them to pass, and thus guarantee road safety.

In examples, the method may further comprise an operation 161 of identifying the detected vehicle as corresponding to a priority vehicle when the priority vehicle detection index is greater than a predetermined detection threshold.

In examples, at least one zone of interest Zr, and advantageously each of the zones of interest Zr, of a detected vehicle is devoid of at least one among: a headlight of the detected vehicle and a direction indicator of the detected vehicle. This makes it possible to increase the reliability of the priority vehicle detection index determined at the end of the method 100 for a detected vehicle. Specifically, the direction indicators of the detected vehicle could be considered to be a flashing emergency light and thus reduce the robustness of the method.

In examples, at least one region of interest R may be determined for a detected vehicle. A region of interest R may comprise or be composed of a plurality of zones of interest Zr, as illustrated in FIG. 3A in which a first region of interest R1v comprises the first plurality of zones of interest Z_{R1} while a second region of interest R2v comprises the second plurality of zones of interest Z_{R2}.

In examples, prior to operation 160 of determining the detection index, the method 100 may comprise an operation 155 for determining a region confidence index associated with a region of interest R. The region confidence index associated with a region of interest R is determined from at least one zone confidence index of a zone of interest Zᵣ belonging to the region of interest R.

In examples, a confidence index of a region of interest R is associated with a specific color, so that a specific region of interest is associated with a plurality of confidence indices. A confidence index of a region of interest R associated with a specific color is determined from at least one zone confidence index associated with this specific color and associated with a zone of interest Zᵣ belonging to the region of interest R.

In the examples comprising operation 155 of determining a region confidence index, the priority vehicle detection index of the detected vehicle is determined from at least one region confidence index associated with at least one region of interest R of the detected vehicle. Advantageously, the priority vehicle detection index for a detected vehicle may be determined from a plurality of region confidence indices associated with at least one region of interest R determined for this vehicle.

In particular, in examples, the priority vehicle detection index for a specific vehicle may be determined from the region confidence index having the highest value among the indices associated with the regions of interest R determined for the specific vehicle. The other region confidence indices are therefore not retained in the determination of the priority vehicle detection index so as to reduce the number of mathematical operations performed for determining this index, this reducing the complexity of the method while allowing faster execution. Moreover, priority vehicles rarely have emergency lights in two different regions of interest R and so taking into account confidence indices calculated in a plurality of regions of interest R for determining the detection index is not always relevant.

It is understood here that insofar as the camera on board the vehicle acquires images in real time, the confidence indices associated with the zones of interest Zᵣ and possibly with the regions of interest R and the priority vehicle detection index of a vehicle detected by the method 100 may be updated with each new image acquired. Tracking of the detected vehicles is therefore carried out with a modification of the various indices as the images are acquired in order to update the priority vehicle detection index in real time.

In examples, the method 100 may also comprise an operation 152 of classifying a zone of interest Zᵣ as being active or inactive depending on a zone confidence index associated with this zone of interest Zr. In particular, the zone confidence index may be compared with an activation threshold such that the zone of interest is classified as active when the zone confidence index is greater than the activation threshold. The activation threshold used may correspond to a hysteresis threshold. Furthermore, it is understood that a zone classified as active may subsequently be classified as inactive when the zone confidence index is recalculated upon the acquisition of a new image by the on-board camera.

In examples in which a zone confidence index of a zone of interest Zᵣ is associated with a specific color, the zone of interest Zᵣ may be classified as active or inactive for the specific color. This classification is carried out depending on the zone confidence index associated with the specific color. The zone of interest is therefore classified as active for the specific color when the confidence index associated with this color is greater than the activation threshold.

In examples, a region confidence index of a region of interest R may be determined from a weight obtained depending on:
a positioning of the zones of interest Zᵣ classified as active in the region of interest; and/or
a color associated with the zones of interest Zᵣ classified as active in the region of interest.

In examples, the weight may change proportionally with the number of zones of interest that are active in the region of interest R.

In examples, the weight may change proportionally to the number of different colors for which the zones of interest of a region are active in the region of interest R.

In examples, when a plurality of zones of interest are active for different colors, the weight obtained is greater than when these zones are active for a single color.

In examples, a weight may be assigned to patterns formed by a selection of zones of interest Zᵣ so that when the zones of interest Zᵣ forming a pattern are classified as active, the weight used to determine the confidence index of the region R corresponds to the weight assigned to the pattern in question. The pattern may be a geographical pattern (arrangement of the zones of interest that are active in the region of interest R) and/or a colorimetric pattern (one or more zones of interest that are active for different colors). “Pattern” is therefore understood to mean a selection of zones of interest Zᵣ classified as active or non-active; in other words, an arrangement of flashing emergency lights.

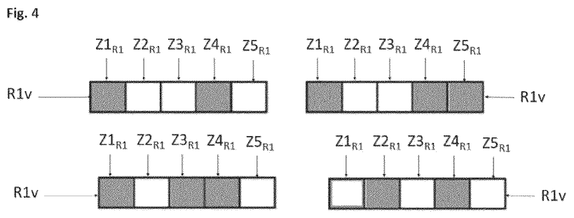

An example of a pattern with which a weight may be associated may, for example, correspond to a pattern comprising a first zone of interest classified as active and a second zone of interest classified as active, the first and the second zone of interest being separated from one another by at least one zone classified as inactive. A number of examples of this type of pattern are shown in FIG. 4 illustrating the zones of interest Z_{R1} associated with the first region of interest R1v. In the examples illustrated in FIG. 4, the filled zones of interest Z_{R1} are considered to be zones classified as active while the empty zones of interest Z_{R1} are considered to be zones classified as inactive.

In one particular example, a region confidence index of a specific region of interest R may correspond to the maximum value of the zone confidence index of the zones of interest Zᵣ comprised in or composing the specific region of interest R multiplied by the weight obtained from the positioning and/or from the color of the zones of interest Zᵣ of the specific region of interest R classified as active.

In examples in which the zones of interest Zᵣ may be activated for various colors, operation 161 of identifying the detected vehicle as corresponding to a priority vehicle may be carried out:
when the priority vehicle detection index is greater than a predetermined detection threshold, and
when a confidence index associated with a specific color corresponding to a color used by the priority vehicles in the geographical area in which the specific vehicle that has the camera on board is traveling is greater than a predetermined threshold.

Specifically, the color of the flashing emergency lights of priority vehicles depends in particular on the legislation of the geographical area in which the vehicle is traveling, this legislation possibly being different depending on the country. Therefore, taking into account the color of the lights selected as possibly corresponding to a flashing emergency light in the identification of a priority vehicle makes it possible to adapt to the various colors used by priority vehicles in various geographical areas of the world. This thus makes it possible to avoid erroneous identifications when the colors identified on the detected vehicle and the colors used by priority vehicles in the geographical area in which the specific vehicle which has the camera on board is traveling do not correspond.

Thus, the method presented by the present disclosure makes it possible to determine an index indicating the probability that a vehicle detected by a camera on a vehicle is a priority vehicle, and, in some examples, makes it possible to determine whether or not the detected vehicle is a priority vehicle. The method is therefore particularly advantageous insofar as driving assistance functions can use this information to act accordingly, and in particular to make it easier for detected priority vehicles to pass if necessary. Moreover, insofar as the method 100 relies on pre-existing vehicle detection and light detection functions, its implementation does not require significant modification of the consequent software architecture present in vehicles using driving assistance functions and/or autonomous driving functions.

1. A method for processing a plurality of images acquired by a camera on board a specific vehicle, each image of the plurality of images being associated with a respective acquisition time, the method comprising the following operations:
detecting at least one vehicle traveling in the same direction as the specific vehicle from the plurality of acquired images;
determining for a detected vehicle, a plurality of zones of interest of the vehicle shared by images of the plurality of images and being likely to comprise at least one flashing emergency light of a priority vehicle;
detecting lights present in the images of the plurality of images;
creating a record indicating, for each image of the plurality of images, a presence or an absence of a light in each of the zones of interest from the detected lights;
determining, for at least one zone of interest a zone confidence index from the information associated with the zone of interest in question listed in the record; and
determining a priority vehicle detection index indicating the probability that the detected vehicle is a priority vehicle from a zone confidence index of at least one zone of interest of the detected vehicle.

2. The method as claimed in claim 1, wherein the determination of a zone confidence index of a zone of interest comprises, when a light of one and the same color has been detected in a plurality of images of the plurality of images as being at least partially in the zone of interest, determining at least one characteristic among:
a flashing frequency of the detected light;
a flashing variance in the detected light;
an average phase duration during which the detected light is on; or
an average phase duration during which the detected light is off;
and the confidence index associated with a zone of interest of the detected vehicle is determined from the at least one characteristic.

3. The method as claimed in claim 1, wherein a zone confidence index is associated with a specific color, so that a specific zone of interest is associated with a plurality of confidence indices when a plurality of lights of different colors have been respectively detected in a plurality of images of the plurality of images as present in the zone of interest.

4. The method as claimed in claim 1, wherein the method further comprises the following operations:
determining, for a detected vehicle, at least one region of interest comprising a plurality of zones of interest;
determining, for each region of interest, a region confidence index, the region confidence index of a region of interest being determined from at least one zone confidence index of a zone of interest belonging to the region of interest;
and wherein a priority vehicle detection index is determined from a region confidence index of at least one region of interest.

5. The method as claimed in claim 4, wherein the method further comprises the following operation:
classifying a zone of interest as being active or inactive depending on a value of a confidence index associated therewith; and
a region confidence index of a region of interest is also determined from a weight calculated depending on at least one among:
a) a positioning of the zones of interest classified as being active in a region of interest; or
b) a color associated with the zones of interest classified as being active in a region of interest.

6. The method as claimed in claim 4, wherein
a specific detected vehicle is a car or a truck;
and the at least one specific region of interest determined for the specific detected vehicle comprises at least one region of interest among:
a) a first region of interest corresponding to an upper portion of the specific vehicle positioned at the level of the roof in the image; or
b) a second region of interest corresponding to a central band of the specific vehicle and extending between the two front lights of the specific vehicle.

7. The method as claimed in claim 6, wherein the second region of interest is devoid of the direction indicators of the vehicle.

8. The method as claimed in claim 1, wherein a specific detected vehicle is a motorcycle and the plurality of zones of interest of the motorcycle comprise at least one zone of interest among:
a) a first zone of interest corresponding to a first side band extending from a first end of the windshield of the motorcycle and comprising a first rear-view mirror of the motorcycle;
b) a second zone of interest extending between two ends of the windshield of the motorcycle that are located in one and the same horizontal plane; or
c) a third zone of interest corresponding to a second side band extending from a second end of the windshield of the motorcycle and comprising a second rear-view mirror of the motorcycle.

9. The method as claimed in claim 1, wherein, when the priority vehicle detection index is greater than a predetermined detection threshold for a detected vehicle, the method further comprises the following operation:
identifying the detected vehicle as corresponding to a priority vehicle.

10. A data-processing device configured to perform any one of the methods as claimed in claim 1.

11. The method as claimed in claim 2, wherein a zone confidence index is associated with a specific color, so that a specific zone of interest is associated with a plurality of confidence indices when a plurality of lights of different colors have been respectively detected in a plurality of images of the plurality of images as present in the zone of interest.

12. The method as claimed in claim 5, wherein a specific detected vehicle is a car or a truck;
and the at least one specific region of interest determined for the specific detected vehicle comprises at least one region of interest among:
a) a first region of interest corresponding to an upper portion of the specific vehicle positioned at the level of the roof in the image; or
b) a second region of interest corresponding to a central band of the specific vehicle and extending between the two front lights of the specific vehicle.
